(19) United States
(12) Patent Application Publication
(10) Pub. No.: US 2007/0028771 A1
(43) Pub. Date: Feb. 8, 2007

(54) Adsorption apparatus, semiconductor device manufacturing facility comprising the same, and method of recycling perfulorocompounds

(76) Inventors: Ji-Young Shin, Seoul (KR); Chung-Sam Jun, Suwon-si (KR); Kye-Weon Kim, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/498,017

(22) Filed: Aug. 3, 2006

(30) Foreign Application Priority Data
Aug. 3, 2005 (KR) 2005-71142

(51) Int. Cl. B01D 53/02

(52) U.S. Cl. 95/131

(57) ABSTRACT

PFC is recycled from a gas mixture using adsorption technology and techniques. Two adsorption units each include an adsorbent having a selectivity by which the PFC is selectively adsorbed with respect to the other gas(es) that make up the mixture. The gas mixture is selectively supplied to one of the first and second adsorption units and a condition is created in the first adsorption unit so that the PFC is adsorbed in the first adsorption unit. Once the adsorbent is saturated in the first adsorption unit, a condition is created in the first adsorption unit that causes the PFC to be desorbed. At this time, the gas mixture is selectively supplied to the second adsorption unit, and a condition is created in the second adsorption unit so that the PFC is adsorbed. Once the adsorbent is saturated in the second adsorption unit, a condition is created in the second adsorption unit that causes the PFC to be desorbed. High-purity PFC gas can be obtained from the exhaust gas even if the gas mixture is exhaust gas of a semiconductor device manufacturing process having a low concentration of PFC.

### BACKGROUND OF THE INVENTION

1. Field of the Invention

The present invention relates to a method of and an apparatus for recycling perfluorocompounds. More particularly, the present invention relates to a method of and an apparatus for recycling perfluorocompounds using adsorption separation technology.

2. Description of the Related Art

Perfluorocompounds (PFCs) are widely used throughout the semiconductor device manufacturing industry. In particular, perfluorocompounds (PFCs) are used in chemical vapor deposition (CVD), etching, and chamber cleaning processes. For example, CF₄ or C₂F₆ gas is widely used in the etching of semiconductor substrates. Most of these PFC gases are nonvolatile and thus are very stable. Also, the PFC gases have a long retention time in the atmosphere and absorb ultraviolet rays radiating from the Earth. Thus, the PFC gases have a very high global warming potential (GWP). Despite this, the use of PFCs is increasing in the semiconductor device manufacturing industry.

Several techniques, though, have been developed to reduce PFC emissions. One method for preventing PFC gas from being emitted into the atmosphere is to burn the PFC component of gas being discharged from semiconductor device manufacturing equipment. This method decomposes PFC gas effectively and thus, prevents environmental pollution. However, hydrogen fluoride is generated as a byproduct of the combustion process. Therefore, this method has problems in terms of its duration and stability. Also, the combustion process requires fuel and oxygen. Thus, additional operational costs are incurred when the combustion method is incorporated into the overall manufacturing process. Another method of suppressing the discharge of PFC gas is a distillation method. However, it is difficult to separate PFC gas from the discharge gas using distillation because of the physical properties of PFC gas. In addition, distillation requires specialized equipment which, again, adds to the cost of the manufacturing process.

### SUMMARY OF THE INVENTION

Objects of the present invention are to provide a recycling method and apparatus in which high-purity PFC gas can be obtained from a gas mixture having a low-concentration of the PFC gas.

Another object of the present invention is to provide a low cost and efficient way to handle exhaust gas containing a PFC gas without emitting the PFC gas into the atmosphere.

Still another object of the present invention is to provide a semiconductor device manufacturing facility that curbs the emission of PFCs without the use of expensive auxiliary equipment.

Still another object of the present invention is to provide a semiconductor device manufacturing facility that efficiently recycles PFCs used in the facility.

According to one aspect of the present invention, PFC is recycled from an exhaust gas using adsorption and desorption cycles.

According to another aspect of the present invention, an apparatus is provided in which the adsorption and desorption cycles can be executed simultaneously.

The present invention provides a method of recycling a PFC in which initially a gas mixture including a PFC gas is selectively supplied to the first of first and second adsorption units each including an adsorbent. At this time, the PFC gas is adsorbed in the first adsorption unit. The PFC is desorbed in the first adsorption unit once the adsorbent is saturated. The gas mixture is also selectively supplied to and adsorbed in the second adsorption unit. The PFC gas is then desorbed in the second adsorption unit once the adsorbent of the second adsorption unit is saturated. Finally, the desorbed PFC gas is recollected.

The steps may be repeated after the PFC gas is desorbed in the second adsorption unit. Also, the gas mixture may be selectively supplied to and adsorbed in the second adsorption unit while PFC gas is being desorbed in the first adsorption unit. Similarly, the gas mixture may be selectively supplied to and adsorbed in the first adsorption unit while PFC gas is being desorbed in the second adsorption unit. In addition, the first adsorption unit may be kept at room temperature and atmospheric pressure while the PFC gas is being adsorbed therein. Alternatively, a relatively low temperature and high pressure may be maintained in the first adsorption unit to facilitate the adsorption of the PFC gas. On the other hand, a relatively high temperature and low pressure are maintained in the first adsorption unit to facilitate the desorbing of the PFC gas. Likewise, the second adsorption unit may be kept at room temperature and atmospheric pressure while the PFC gas is being adsorbed therein. Alternatively, a relatively low temperature and high pressure may be maintained in the second adsorption unit to facilitate the adsorption of the PFC gas. On the other hand, a relatively high temperature and low pressure are maintained in the second adsorption unit to facilitate the desorbing of the PFC gas.

Also, the first adsorption unit may be pressurized before the gas mixture containing the PFC gas is introduced into the first adsorption unit. Similarly, the second adsorption unit may be pressurized before the gas mixture containing the PFC gas is introduced into the second adsorption unit. To this end, the non-adsorbed gas in one adsorption unit may be supplied from that unit to the other unit in which the adsorption of PFC gas is about to take place.

The present invention also provides a method of recycling perfluorocompound (PFC) in which a gas mixture containing PFC gas is supplied to a first adsorption unit and the PFC gas is adsorbed in the first adsorption unit, and the PFC gas is then desorbed in the first adsorption unit while the second adsorption unit is pressurized and the gas mixture is supplied to the second adsorption unit. Thus, PFC gas is adsorbed in the second unit while PFC gas is being desorbed in the first adsorption unit. Next, the PFC gas is desorbed in the second adsorption unit while the first adsorption unit is pressurized and the gas mixture is selectively supplied to the first adsorption unit. Thus, PFC gas is adsorbed in the first adsorption unit while PFC gas is being desorbed in the second adsorption unit.

The first adsorption unit may be initially pressurized with nitrogen. Then, the second adsorption unit is pressurized by supplying it with the non-adsorbed gas from the first adsorption unit. Similarly, in subsequent cycles in which PFC gas is to be adsorbed in the first adsorption unit, the first adsorption unit is pressurized by supplying it with non-adsorbed gas from the second adsorption unit.

The present invention also provide an adsorption apparatus for recycling a perfluorocompound (PFC), which includes first and second adsorption units, a first pipe to which inlets of the first and second adsorption units are commonly connected, valves disposed in-line between the first pipe and the inlets of the first and second adsorption units, respectively, second and third pipes respectively connected to outlets of the first and second adsorption units, valves disposed in-line with the second and third pipes, respectively, a fourth pipe interconnecting the first and second adsorption units, and a valve disposed in-line with the fourth pipe. The valves are movable to positions at which gas that is not adsorbed by an adsorbent of the first adsorption unit flows through the fourth pipe into the second adsorption unit, and to positions at which gas that is not adsorbed by an adsorbent of the second adsorption unit flows through the fourth pipe into the first adsorption unit the adsorption apparatus may also includes a storage tank connected to the second and third pipes for storing the PFC desorbed in the first and second adsorption units.

The adsorbent may be silica gel, activated alumina, zeolite or activated carbon. Preferably, the adsorbent is activated carbon because activated carbon has a relatively great ability to adsorb PFCs.

The present invention also provides a semiconductor manufacturing facility in which the adsorption apparatus is connected to the exhaust line of a reaction chamber of a processing apparatus in which substrates are processed using PFC gas.

### BRIEF DESCRIPTION OF THE DRAWINGS

These and other objects, features and advantages of the invention will be better understood from the following detailed description of the preferred embodiments thereof made with reference to the accompanying drawings. In the drawings:

FIG. 1 is a schematic diagram of an embodiment of a semiconductor device manufacturing facility including an adsorption apparatus according to the present invention;

FIG. 2 is a flowchart of a method of recycling PFCs according to the present invention; and

FIG. 3 is a schematic diagram of another embodiment of a semiconductor device manufacturing facility including an adsorption apparatus according to the present invention.

### DETAILED DESCRIPTION OF THE PREFERRED EMBODIMENTS

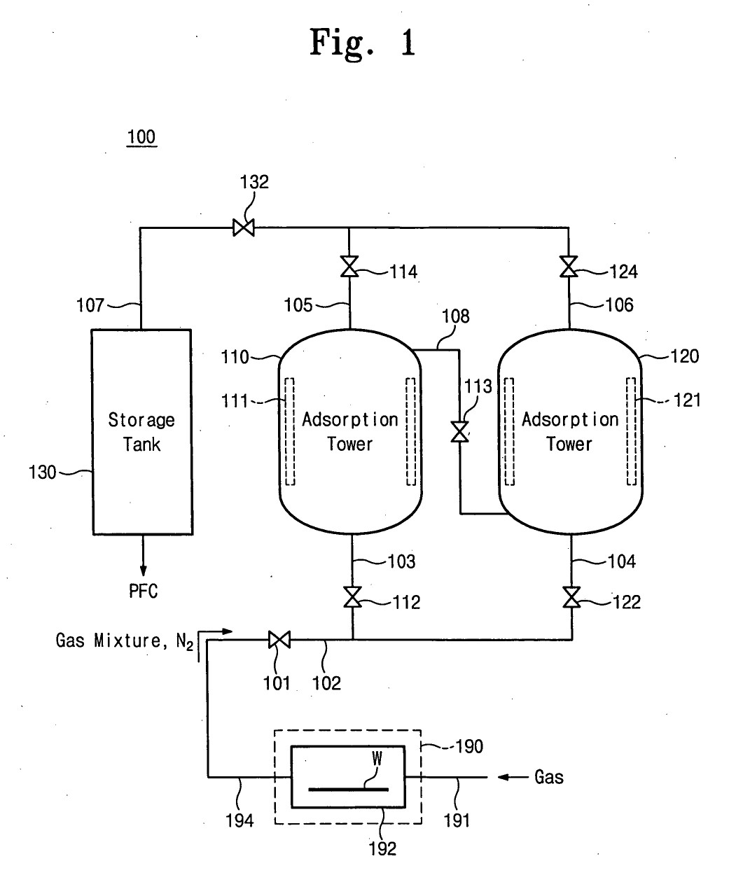

Referring to FIG. 1, an adsorption apparatus 100 for recycling PFC gas according to the present invention includes at least two adsorption devices 110 and 120, such as adsorption towers or adsorption beds. For the sake of simplicity, the present invention will be described hereinafter with respect to the adsorption devices 110 and 120 being adsorption towers.

A reaction chamber 192 of a semiconductor device processing apparatus 190, such as an etch apparatus, is connected to inlets of the two adsorption towers 110 and 120 through main gas feed pipe 102 and branch pipes 103 and 104. More specifically, an exhaust line 194 extends between and connects the reaction chamber 192 and the main gas feed pipe 102. Gas including PFC is introduced into the reaction chamber 192 through a gas supply line 191. A semiconductor substrate W is processed in the reaction chamber 192 and gas is discharged from the reaction chamber through the exhaust line 194. The gas thus flows into the main gas feed pipe 102. The branch pipes 103 and 104 are commonly connected to the main gas feed pipe 102, and are respectively connected to the adsorption towers 110 and 120. Valves 101, 112 and 122 are disposed in the pipes 102, 103 and 104, respectively. Each of the valves can be moved between open and closed positions to selectively allow and block the flow of gas through the pipe in which the valve is disposed. Thus, a mixture of gas discharged from the semiconductor device processing apparatus 190 is supplied to the first adsorption tower 110 or the second adsorption tower 120 through the pipe 103 or 104, respectively, depending on whether valves 112 and 122 are open or closed. The exhaust gas contains PFC gas. For example, the exhaust gas includes excess CF₄ or C₂F₆, used as an etching gas in a process of etching a semiconductor substrate W.

The adsorption towers 110 and 120 are filled with an adsorbent, such as silica gel, activated alumina, zeolite, or activated carbon that will adsorb PFC gas with a relatively high selectivity with respect to other gases that may make up the exhaust gas. Preferably, the adsorbent is activated carbon because among the above-mentioned adsorbents, activated carbon has the greatest ability to adsorb PFC gas. Therefore, PFC gas can adsorbed in the adsorption towers 110 and 120 until the adsorbent is saturated with the gas. Also, PFC will be adsorbed or desorbed by the adsorbent (e.g., activated carbon) depending on the pressure and temperature in the adsorption tower. Therefore, the apparatus also includes a first temperature regulating device 111 for controlling the temperature of the first adsorption tower 110, and a second temperature regulating device 121 for controlling the temperature of the second adsorption tower 120.

The other component(s) of the exhaust gas, that is gas other than the PFC, is not adsorbed in the adsorption towers 110 and 120 but it is emitted into the atmosphere. Such gas will be referred to as non-adsorbed gas. Also, the adsorption towers 110 and 120 are connected to one another by a pipe 108. A valve 113 is disposed in the pipe. The valve may be opened and closed to selectively place the adsorption towers 110 and 120 in communication with each other. Thus, the non-adsorbed gas can be discharged from one adsorption tower to the other through pipe 108.

Pipes 105 and 106 are connected to outlets of the adsorption towers 110 and 120, respectively. The pipes 105 and 106 are commonly connected to a main collection pipe 107. Valves 114, 124 and 132 are disposed in the pipes 105, 106 and 107, respectively. Each of the valves can be moved between open and closed positions to selectively allow and block the flow of PFC gas through the pipe in which the valve is disposed. Thus, PFC gas desorbed in the first adsorption tower 110 flows through the pipes 105 and 107 when the valves 114 and 132 are opened. Likewise, PFC desorbed in the second adsorption tower 120 flows through the pipes 106 and 107 when the valves 124 and 132. The main recollection pipe 107 is connected to a gas storage tank 130. Therefore, the PFC gas desorbed in the first and second adsorption towers 110 and 120 may be recollected and stored in the storage tank 130.

The concentration of PFC gas is relatively low in the exhaust gas discharged during a typical semiconductor device manufacturing process, such as an etch process. Accordingly, the adsorption towers 110 and 120 can be pressurized to cause the adsorbent to more efficiently adsorb the PFC gas. To this end, a source of nitrogen (N₂) is connected to the adsorption towers 110 and 120. The source of nitrogen (N₂) may be connected to the towers 110 and 120 through the main gas feed pipe 102. Alternatively, the adsorption towers 110 and 120 can be pressurized using non-adsorbed gas that is fed through the pipe 108.

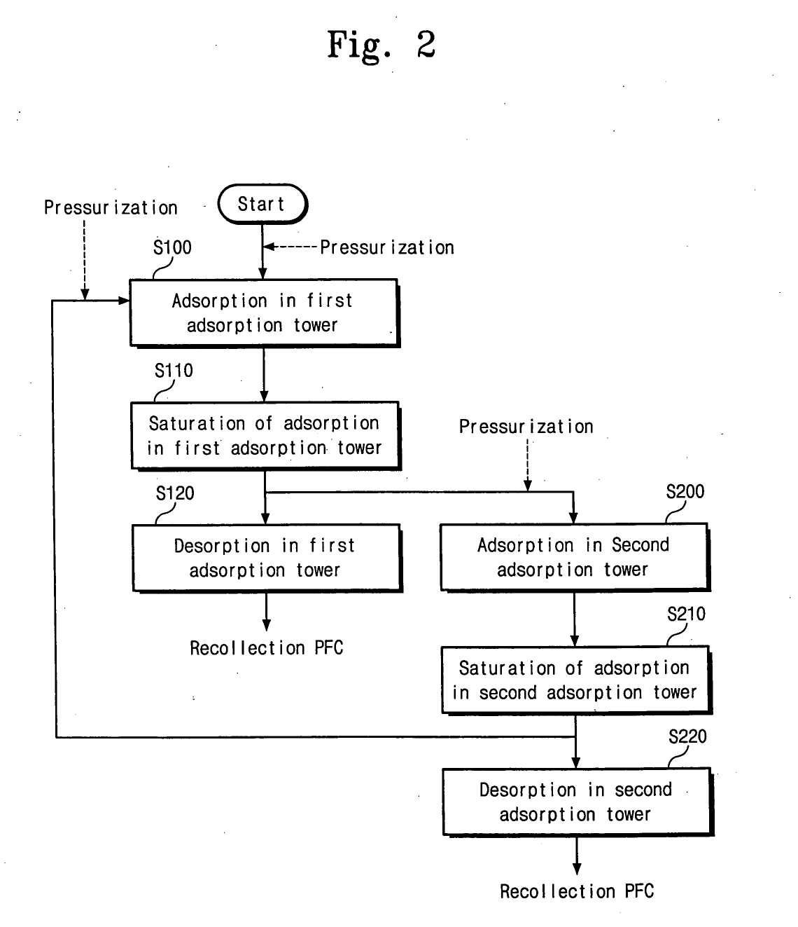

A method of recycling PFC gas using the apparatus of FIG. 1 will now be described in more detail with reference to FIG. 2. At the start of the process, a PFC gas is introduced into a reaction chamber of a substrate processing apparatus. For example, CF₄ and/or C₂F₆ is introduced into a reaction chamber 192 of an etch apparatus 190 as an etching gas. An excess amount of the PFC gas does not react with the substrate W in the reaction chamber 192. Gas is discharged from the reaction chamber 192 during and after the etching process. This exhaust gas thus contains the excess PFC gas. The exhaust gas containing PFC gas, e.g., CF₄ and/or C₂F₆, is discharged from the reaction chamber 192 of the etch apparatus 190 to the pipe 102 via exhaust line 194. The exhaust gas is first supplied to the first adsorption tower 110 by opening the valve 112 and closing the valve 122.

The PFC component of the exhaust gas has a relatively low concentration. Therefore, the first adsorption tower 110 may be pre-pressurized so that the adsorbent will adsorb the low concentration of PFC gas more effectively. Specifically, the first adsorption tower 110 may be pre-pressurized by introducing nitrogen gas into the first adsorption tower 110 through pipes 102 and 103.

The PFC component of the exhaust gas introduced into the first adsorption tower 110 will be adsorbed or desorbed by the adsorbent (preferably activated carbon) depending on the pressure and temperature in the adsorption tower. Specifically, in this type of separation process, the concentration of PFC gas in the adsorbent increases (adsorption) as the gas pressure increases and temperature decreases, and the concentration of PFC gas in the adsorbent decreases (desorption) when the gas pressure decreases and temperature increases.

A condition is established in the first adsorption unit so that the gas comprising a PFC will be adsorbed by the adsorbent of the first adsorption unit. For example, the first adsorption unit may be maintained at room temperature and atmospheric pressure. However, alternatively, a relatively high pressure and low temperature condition is established in the first adsorption tower 110. The exhaust gas is injected into the first adsorption tower 110 through branch pipe 103. Therefore, the PFC component of the exhaust gas is selectively adsorbed by the adsorbent (e.g., activated carbon) in the first adsorption tower 110 (S100). On the other hand, the non-adsorbed gas passes through the adsorption tower 110 to the second adsorption tower 120 through the pipe 108 to pre-pressurize the second adsorption tower 120.

The exhaust gas is fed into the first adsorption tower 110 until the adsorbent is saturated with the PFC gas (S110). Then, the PFC gas is desorbed (S120) by establishing a condition in the first adsorption tower 110, that is, a low pressure (e.g., close to a vacuum level) and high temperature condition (e.g., 100° C.), under which the absorbent will give up PFC gas. At this time, the valves 114 and 132 are opened. As a result, the desorbed PFC gas flows through the pipe 105 so as to be recollected. The recollected PFC gas may be stored in the storage tank 130.

In addition, the valve 122 is opened while desorption is taking place in the first adsorption tower 110. Accordingly, the exhaust gas is supplied to the second adsorption tower 120 through the pipe 104. As a result, the PFC component of the exhaust gas is adsorbed in the second adsorption tower 120 (S200). To this end, the condition that was established in the first adsorption tower 110 to facilitate the adsorption of PFC gas by the adsorbent, e.g., a high pressure and low temperature condition, is established in the second adsorption tower 120. Also, if the second adsorption tower is pre-pressurized by the non-adsorbed gas flowing from the first adsorption tower 110, the PFC gas is adsorbed more effectively.

The exhaust gas is fed into the second adsorption tower 120 until the adsorbent in the second adsorption tower 120 is saturated (S210). At this time, the conditions under which PFC is desorbed from the adsorbent are established in the second adsorption tower 120 (S220). That is, again, a low pressure and high temperature condition is established in the second adsorption tower 120. Then, the PFC gas flows through the pipe 106 and is recollected, e.g., is stored in the storage tank 130 along with PFC gas desorbed in the first adsorption tower 110. The valve 112 is opened while the desorption is taking place in the second adsorption tower 120 so that the exhaust gas is introduced into the first adsorption tower 110, whereby another cycle in which PFC gas is adsorbed in the first adsorption tower 110 takes place.

Also, during the time in which the PFC gas is being adsorbed in the second adsorption tower 120 (S200), the non-adsorbed gas in the second adsorption tower 120 is introduced into the first adsorption tower 110 through the pipe 108. In this way, the first adsorption tower 110 is pre-pressurized. That is, the first adsorption tower 110 is initially pressurized by supplying nitrogen gas into the first adsorption tower 10; then, for each cycle after that in which adsorption is to take place in the first adsorption tower 110, the first adsorption tower 110 is pre-pressurized with non-adsorbed gas from the second adsorption tower 120.

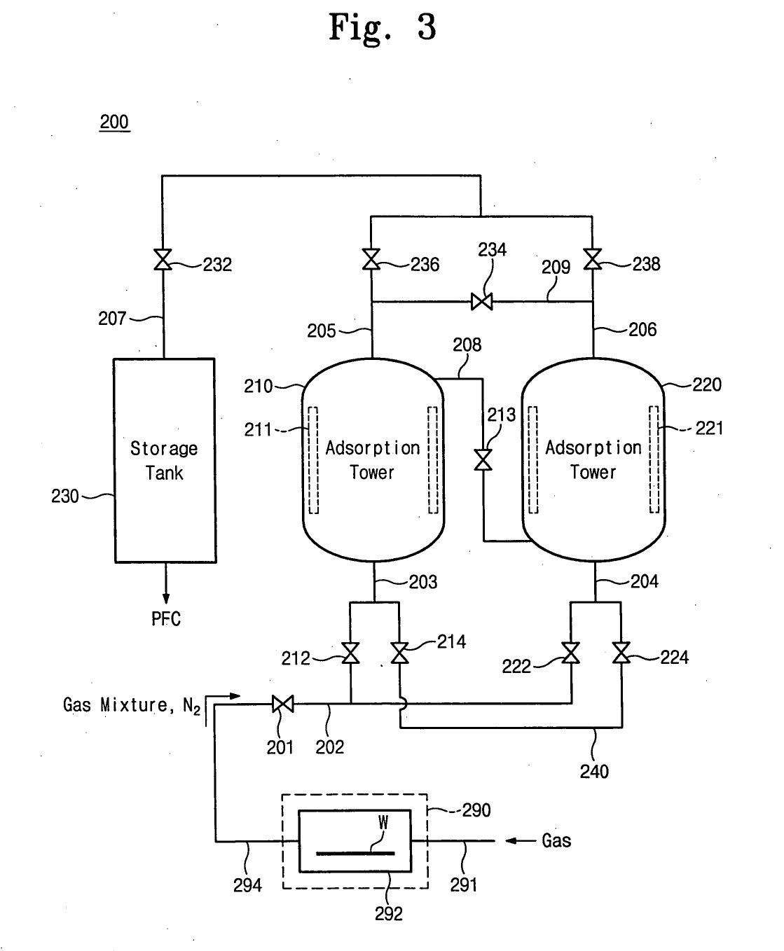

As is clear from the description above, PFC gas is efficiently recollected because the adsorption/desorption processes are continuously and simultaneously taking place. Specifically, after the initial adsorption process, adsorption is always taking place in one of the first and second adsorption towers 110 and 120 while desorption is taking place in the other of the first and second adsorption towers 110 and 120. The recollected gas may contain a slight amount of gas other than pure PFC gas. In this case, the recollected gas is again supplied to the first adsorption tower and the second adsorption tower, and the adsorption and desorption processes are repeated on the recollected gas. Consequently, PFC gas of a higher purity can be obtained. To this end, an adsorption apparatus as shown in FIG. 3 may be used.

Referring to FIG. 3, the adsorption apparatus 200 includes two adsorption towers 210 and 220, a main exhaust gas feed pipe 202 connected to the reaction chamber 292 of a processing apparatus 290 of semiconductor device manufacturing equipment so as to receive exhaust gas discharged from the reaction chamber, and branch pipes 203, 204. A temperature regulating device 211 controls the temperature of the first adsorption tower 210. Likewise, a second temperature regulating device 221 controls the temperature of the second adsorption tower 220.

A semiconductor device processing apparatus 290 is connected to the adsorption apparatus. More specifically, an exhaust line 294 extends between and connects a reaction chamber 292 of the processing apparatus 290 and the main gas feed pipe 202. Gas including PFC is introduced into the reaction chamber 292 through a gas supply line 291. A semiconductor substrate W is processed in the reaction chamber 292 and gas is discharged from the reaction chamber through the exhaust line 294. Thus, the discharged gas will flow to the main exhaust gas feed pipe 202. The branch pipes 203, 204 are commonly connected to the main exhaust gas feed pipe 202 and are connected to the adsorption towers 210 and 220, respectively.

In addition, valves 212, 222 are disposed in-line in the branch pipes 203, 204, respectively. The valves 212 and 222 are movable between open and closed positions to selectively allow and block the flow of gas to the adsorption towers 210 and 220. That is, gas selectively flows through pipes 203 and 204 according to the positions of the valves 212 and 222.

Pipes 205 and 206 are connected to outlets of the adsorption towers 210 and 220, respectively. Thus, PFC adsorbed and then desorbed in the adsorption towers 210 and 220 flows through pipes 205 and 206 so as to be recollected. The pipes 205 and 206 are connected in common to a main recollection pipe 207. The main recollection pipe 207 is, in turn, connected to a gas storage tank 208. Thus, the gas may be stored in the storage tank 208 as it is recollected.

Furthermore, a return pipe 209 interconnects the pipes 205 and 206. A valve 234 is disposed in the return pipe 209 to selectively allow and block the flow of gas through the pipe 209. Also, valves 236 and 238 are disposed in the pipes 236 and 205, 206, respectively, between the locations at which the return pipe 209 interconnects the pipes 205 and 206 and the locations at which the pipes 205 and 206 are connected to the main recollection pipe 207. Thus, the valve 234 may be opened and the valves 236 and 238 may be closed so that the recollected gas flowing from one of the adsorption towers 210 and 220 may be returned to the other of the adsorption towers 210 and 220 through the return pipe 209, whereupon the adsorption and desorption processes are repeated on the recollected gas. In addition, valves 214 and 224 are disposed in series in-line in a return pipe 240. The valves 214 and 224 may be opened so that recollected gas flowing from one of the adsorption towers 210 and 222 may be returned to the other of the adsorption towers 210 and 22 through the return pipe 240.

Otherwise, the operation of the adsorption apparatus 200 is essentially the same as that described with reference to FIG. 2. For instance, the adsorption towers 210 and 220 are connected to one another by a pipe 208. A valve 213 is disposed in the pipe. The valve may be opened and closed to selectively place the adsorption towers 110 and 120 in communication with each other. Thus, the non-adsorbed gas can be introduced from one of the adsorption towers 210 and 220 to the other of the adsorption towers 210 and 220 through the pipe 208 to pressurize the other of the adsorption towers 210 and 220.

According to the present invention, as described above, PFC gas can be separated from the exhaust gas of semiconductor device manufacturing equipment merely by controlling the pressure and temperature of an adsorption unit. Thus, the present invention provides an economical approach to handling exhaust gas of the type that typically has a low concentration of PFC gas, such as that of produced by semiconductor device manufacturing equipment. Also, the adsorption/desorption process itself is an effective way to separate out the PFC gas from the exhaust gas which typically contains a low concentration of the PFC gas. Moreover, PFC gas which is known to contribute to global warming is prevented from being emitted into the atmosphere. Also, the present invention recollects high purity PFC gas from the exhaust gas. Thus, its reuse is possible. Any non-adsorbed gas can be discharged with the use of a mass flow controller (MFC).

Finally, although the present invention has been described above in connection with the preferred embodiments thereof, the present invention is not so limited. Rather, various modifications of the disclosed embodiments will be apparent to those skilled in the art that. Thus, modifications of the disclosed embodiments are seen to be within the true spirit and scope of the invention as defined by the appended claims.

What is claimed is:

1. A method of recycling gas comprising a perfluorocompound (PFC), comprising:
a) supplying an exhaust gas mixture including a gas comprising a PFC to the first of first and second adsorption units each comprising an adsorbent, wherein the adsorbent has a selectivity by which the adsorbent selectively adsorbs the gas comprising a PFC with respect the mixture adsorbs under certain conditions, and wherein the adsorbent desorbs the gas comprising a PFC under certain other conditions;
b) creating a condition in the first adsorption unit under which the gas comprising a PFC will be adsorbed by the adsorbent of the first adsorption unit, until the adsorbent of the first adsorption unit is saturated with the PFC;
c) subsequently creating a condition in the first adsorption unit under which the the gas comprising a PFC is desorbed from the saturated adsorbent;
d) after the adsorbent of the first adsorption unit is saturated, selectively supplying the exhaust gas to the second of the first and second adsorption units;
e) creating a condition in the second adsorption unit under which the gas comprising a PFC will be adsorbed by the adsorbent of the first adsorption unit, until the adsorbent of the second adsorption unit is saturated with the PFC;
f) subsequently creating a condition in the second adsorption unit under which the gas comprising a PFC is desorbed from the saturated adsorbent of the second adsorption unit; and
g) recollecting the gas comprising a PFC desorbed by the adsorbents of the first and second adsorption units.

2. The method of claim 1, wherein b)-e) are repeated after f).

3. The method of claim 2, wherein c) and e) are simultaneously performed.

4. The method of claim 2, wherein f) and b) are simultaneously performed.

5. The method of claim 2, wherein b) comprises creating room temperature and atmospheric pressure in the first adsorption unit, and c) comprises creating a temperature higher than that of room temperature and a pressure lower than that of atmospheric pressure in the first adsorption unit.

6. The method of claim 2, wherein b) comprises creating a temperature below room temperature and pressure greater than atmospheric pressure in the first adsorption unit, and c) comprises creating a temperature higher than that of room temperature and a pressure lower than that of atmospheric pressure in the first adsorption unit.

7. The method of claim 2, wherein e) comprises creating room temperature and atmospheric pressure in the second adsorption unit, and f) comprises creating a temperature higher than that of room temperature and a pressure lower than that of atmospheric pressure in the second adsorption unit.

8. The method of claim 2, wherein e) comprises creating a temperature below room temperature and pressure greater than atmospheric pressure in the second adsorption unit, and f) comprises creating a temperature higher than that of room temperature and a pressure lower than that of atmospheric pressure in the second adsorption unit.

9. The method of claim 2, further comprising pressurizing the first adsorption unit before a).

10. The method of claim 9, wherein the pressurizing of the first adsorption unit includes supplying gas of the mixture from the second adsorption unit, and which gas is not adsorbed by the adsorbent of the second adsorption unit, to the first adsorption unit.

11. The method of claim 2, further comprising pressurizing the second adsorption unit before d).

12. The method of claim 11, wherein the pressurizing of the second adsorption unit includes supplying gas of the mixture from the first adsorption unit, and which gas is not adsorbed in the first adsorption unit, to the second adsorption unit.

13. A method of recycling a gas comprising a perfluorocompound (PFC), comprising:
a) pressurizing a first adsorption unit comprising an adsorbent, and supplying a gas mixture including a gas comprising a PFC to the first adsorption unit, wherein the adsorbent has a selectivity by which the adsorbent selectively adsorbs the gas comprising a PFC with respect the mixture;
b) subsequently creating a condition in the, first adsorption unit under which the PFC gas is desorbed from adsorbent of the first adsorption unit and simultaneously pressurizing a second adsorption unit comprising an adsorbent, and supplying the gas mixture to the second adsorption unit, wherein the adsorbent of the second adsorbent unit has a selectivity by which the adsorbent selectively adsorbs the gas comprising a PFC with respect the mixture; and
c) subsequently creating a condition in the second adsorption unit under which the gas comprising a PFC is desorbed from the adsorbent of the second adsorption unit and simultaneously pressurizing the first adsorption unit, and supplying the first adsorption unit with the gas mixture.

14. The method of claim 13, wherein the pressurizing of the first adsorption unit in a) includes supplying nitrogen into the first adsorption unit.

15. The method of claim 13, wherein the pressurizing of the second adsorption unit in b) includes supplying gas of the mixture from the first adsorption unit, and which gas is not adsorbed by the adsorbent of the first adsorption unit, to the second adsorption unit.

16. The method of claim 13, wherein the pressurizing the first adsorption unit of c) includes supplying gas of the mixture from the second adsorption unit, and which gas is not adsorbed by the adsorbent of the second adsorption unit, to the first adsorption unit.

17. An adsorption apparatus for recycling a gas comprising a perfluorocompound (PFC), comprising:
first and second adsorption units each comprising a housing, an inlet and an outlet, and an adsorbent disposed in the housing between the inlet and outlet, the adsorbent having the ability to absorb a gas comprising a PFC;
a first pipe to which the inlets of the first and second adsorption units are commonly connected;
valves disposed in-line between the first pipe and the inlets of the first and second adsorption units, respectively, whereby the valves are positionable to allow gas flowing through the first pipe to be selectively supplied to the first and second adsorption units;
second and third pipes respectively connected to the outlets of the first and second adsorption units;
valves disposed in-line with the second and third pipes, respectively;
a fourth pipe interconnecting the first and second adsorption units; and
and a valve disposed in-line with the fourth pipe, whereby the valves are movable to positions at which gas that is not adsorbed by the adsorbent of the first adsorption unit flows through the fourth pipe into the second adsorption unit, and to positions at which gas that is not adsorbed by the adsorbent of the second adsorption unit flows through the fourth pipe into the first adsorption unit.

18. The adsorption apparatus of claim 17, further comprising a storage tank connected to the second and third pipes.

19. The adsorption apparatus of claim 17, wherein the adsorbent is selected from the group consisting of silica gel, activated alumina, zeolite, and activated carbon.

20. The adsorption apparatus of claim 19, wherein the adsorbent is activated carbon.

21. A semiconductor device manufacturing facility comprising:
semiconductor device manufacturing equipment including a reaction chamber in which substrates are processed using a gas comprising a perfluorocompound (PFC), and an exhaust system including an exhaust line through which gas is discharged from the reaction chamber;
first and second adsorption units each comprising a housing, an inlet and an outlet, and an adsorbent disposed in the housing between the inlet and outlet, the adsorbent having the ability to absorb a gas comprising a PFC;
a first pipe connected to the exhaust line of the semiconductor device manufacturing equipment and to the inlets of the first and second adsorption units;
valves disposed in-line between the first pipe and the inlets of the first and second adsorption units, respectively, whereby the valves are positionable to allow exhaust gas flowing from the semiconductor manufacturing equipment through the first pipe to be selectively supplied to the first and second adsorption units;
second and third pipes respectively connected to the outlets of the first and second adsorption units; and
valves disposed in-line with the second and third pipes, respectively.

22. The semiconductor device manufacturing facility, further comprising:
a fourth pipe interconnecting the first and second adsorption units; and
and a valve disposed in-line with the fourth pipe, whereby the valves are movable to positions at which gas that is not adsorbed by the adsorbent of the first adsorption unit flows through the fourth pipe into the second adsorption unit, and to positions at which gas that is not adsorbed by the adsorbent of the second adsorption unit flows through the fourth pipe into the first adsorption unit.
